(19) United States
(12) Patent Application Publication
(10) Pub. No.: US 2019/0042331 A1
(43) Pub. Date: Feb. 7, 2019

(54) POWER AWARE LOAD BALANCING USING A HARDWARE QUEUE MANAGER

(71) Applicant: Intel Corporation, Santa Clara, CA (US)

(72) Inventors: Niall D. MCDONNELL, Limerick (IE); Zhu ZHOU, Chandler, AZ (US); John MANGAN, Shannon (IE)

(21) Appl. No.: 16/131,728

(22) Filed: Sep. 14, 2018

(51) Int. Cl. G06F 9/50; G06F 1/32

(52) U.S. Cl. CPC G06F 9/5094; G06F 2209/5011; G06F 1/3287

(57) ABSTRACT

Examples may include a method of power aware load balancing in a computing platform. The method includes computing a number of enabled worker cores to process an expected traffic of received packets. A number of active consumer queues is adjusted based at least in part on the number of enabled worker cores, with consumer queues being associated with worker cores. A worker core polls the consumer queue associated with the worker core, gets and processes a packet descriptor describing a received packet from the consumer queue based on the consumer queue being not empty, and enters a low power state when the consumer queue is empty and pends on a new packet descriptor being entered into the consumer queue.

Portions of the disclosure of this patent document may contain material that is subject to copyright protection. The copyright owner has no objection to the reproduction by anyone of the patent document or the patent disclosure as it appears in the Patent and Trademark Office patent file or records, but otherwise reserves all copyright rights whatsoever. The copyright notice applies to all data as described below, and in the accompanying drawings hereto, as well as to any software described below: Copyright © 2018, Intel Corporation, All Rights Reserved.

### BACKGROUND

Packet processing applications typically provision a number of “worker” processing threads running on processor cores (called “worker cores”) to perform the processing work of the applications. Worker cores consume packets from dedicated queues which in some scenarios is fed by one or more network interface controllers (NICs) or by input/output (I/O) threads. The number of worker cores provisioned is usually a function of the maximum predicted throughput. However, real packet traffic varies widely both in short durations (e.g., seconds) and over longer periods of time (for example, many networks experience significantly less traffic at night or on a weekend).

This gives rise to opportunities for efficiency. Power savings can be obtained if some worker cores can be put in a low power state when the traffic load allows. Alternatively, worker cores that are not required can be redirected to other tasks (e.g., used in other execution contexts) and only recalled when required. Some existing approaches allow applications to be temporarily dropped to a lower power state or use a wait semantic to sleep on the next queue entry. Context switching between the work context and some background context is also possible using interrupt schemes. These techniques can be applied irrespective of the entity that is writing to the queue.

However, it is problematic to vary the number of worker cores. Lookup tables have to be modified and some packets inflight at the time of the change may be lost or go out of order as a result. Packet distribution schemes assume all worker cores are always available which has drawbacks. Worker cores can transition to a low power state when they have no work available, but the time spent transitioning to/from the low power state (or another execution context) can be significant, especially for deeper power states. Cores that transition too frequently risk spending too many cycles on the transition itself, and are therefore not efficient. Schemes that allow all processing cores to transition are more likely to be susceptible to this problem. Latency is incurred for packets that have to wait for a core to wake or switch context. With waiting schemes, it is difficult for processing cores to guarantee low power state residency (since the next packet may wake the core) and intermittent traffic may cause a core to spend its time bouncing in and out of low power states. CPUs that support multiple concurrently operating (hyper)threads complicate issues further. To save significant power, it is usually necessary to have all sibling hyper-threads in a core in a low power state. Without the ability to vary the number of worker cores it is difficult to maximize the likelihood of this occurring. This disadvantage becomes more significant as the number of hyper-threads per core increases.

### BRIEF DESCRIPTION OF THE DRAWINGS

FIG. 1 illustrates an example computing system.

FIG. 2 illustrates an example arrangement of processing cores.

FIG. 3 illustrates an example hardware queue manager (HQM).

FIG. 4 illustrates an example flow diagram of a process to enqueue and dequeue packet descriptors.

FIG. 5 illustrates an example flow diagram of a process to access packet descriptors by a worker core.

FIG. 6 illustrates an example flow diagram of a process to handle credits.

FIG. 7 illustrates an example flow diagram of a first process to control load balancing.

FIG. 8 illustrates an example flow diagram of a second process to control load balancing.

FIG. 9 illustrates an example of a storage medium.

FIG. 10 illustrates another example computing platform.

### DETAILED DESCRIPTION

Embodiments of the present invention provide an approach for power aware load balancing (PALB) of processing cores. This approach leverages a load balancing capability of a hardware queue manager (HQM) to efficiently and dynamically scale the number of enabled worker cores in a computing platform to match a varying workload in an efficient manner while maintaining performance (e.g., throughput, latency) requirements. As well as being power efficient, embodiments can be used in deploying “cloudified” applications in data center systems that can scale up and down in size.

Embodiments of the present invention leverage a load balancing capability of the HQM to dynamically scale the number of enabled worker cores used to process a time variant workload to improve efficiency while maintaining performance (e.g., throughput, latency) requirements. A worker thread is a consumer from the HQM and work is distributed evenly amongst the worker threads on the worker cores. Activity is monitored by a process which dynamically adjusts the number of enabled worker cores in response to changes in the traffic level or based at least in part on external factors and/or conditions. Worker cores that are not in use enter sleep states for overall power reduction, or they context switch to other tasks.

In embodiments of the present invention, worker cores that have been removed from the pool of enabled worker cores do not repeatedly transition between wake and sleep states. Short bursts of high level traffic are buffered in the HQM without necessarily causing new worker cores to be activated. Thus, unused worker cores can enter deep sleep states and save considerable power without causing an impact to system packet latency. Embodiments can be tailored to add/remove sibling hyper-threads simultaneously on multithreaded systems to improve power savings.

Embodiments of the present invention can provide an increase in a low power state sleep occupation time (depending on state transition time) compared to previous approaches. This corresponds to an equivalent saving of active power for the worker cores. Embodiments also demonstrate better deterministic (e.g., lower maximum) latency than other approaches. Embodiments also provide better efficiency and latency when context switching via interrupts.

Although the description contained herein references worker cores, embodiments of the present invention are also applicable to worker threads running on worker cores. That is, worker threads can also be activated and deactivated dynamically according to embodiments of the present invention.

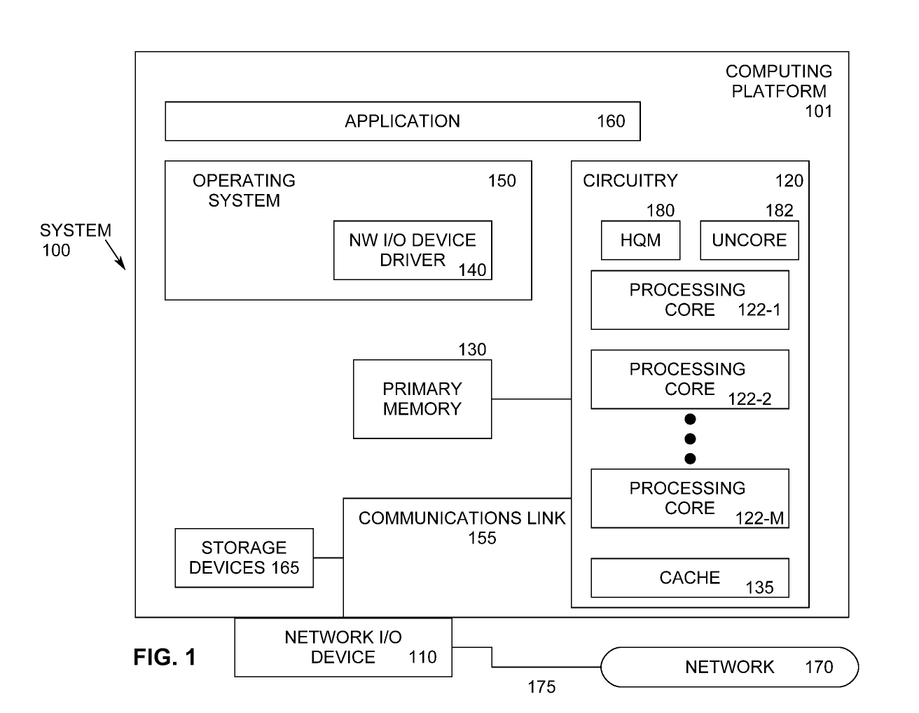

FIG. 1 illustrates an example computing system 100. As shown in FIG. 1, computing system 100 includes a computing platform 101 coupled to a network 170 (which may be the Internet, for example). In some examples, as shown in FIG. 1, computing platform 101 is coupled to network 170 via network communication channel 175 and through at least one network I/O device 110 (e.g., a network interface controller (NIC)) having one or more ports connected or coupled to network communication channel 175. In an embodiment, network communication channel 175 includes a PHY device (not shown). In an embodiment, network I/O device 110 is an Ethernet NIC. Network I/O device 110 transmits data packets from computing platform 101 over network 170 to other destinations and receives data packets from other destinations for forwarding to computing platform 101.

According to some examples, computing platform 101, as shown in FIG. 1, includes circuitry 120, primary memory 130, network (NW) I/O device driver 140, operating system (OS) 150, at least one application 160, and one or more storage devices 165. In one embodiment, OS 150 is Linux™. In another embodiment, OS 150 is Windows® Server. Network I/O device driver 140 operates to initialize and manage I/O requests performed by network I/O device 110. In an embodiment, packets and/or packet metadata transmitted to network I/O device 110 and/or received from network I/O device 110 are stored in one or more of primary memory 130 and/or storage devices 165. In at least one embodiment, application 160 is a packet processing application. In at least one embodiment, storage devices 165 may be one or more of hard disk drives (HDDs) and/or solid-state drives (SSDs). In an embodiment, storage devices 165 may be non-volatile memories (NVMs). In some examples, as shown in FIG. 1, circuitry 120 may communicatively couple to network I/O device 110 via communications link 155. In one embodiment, communications link 155 is a peripheral component interface express (PCIe) bus conforming to version 3.0 or other versions of the PCIe standard published by the PCI Special Interest Group (PCI-SIG) at pcisig.com. In some examples, operating system 150, NW I/O device driver 140, and application 160 are implemented, at least in part, via cooperation between one or more memory devices included in primary memory 130 (e.g., volatile or non-volatile memory devices), storage devices 165, and elements of circuitry 120 such as processing cores 122-1 to 122-m, where “m” is any positive whole integer greater than 2. In an embodiment, OS 150, NW I/O device driver 140, and application 160 are executed by one or more processing cores 122-1 to 122-m.

In some examples, computing platform 101, includes but is not limited to a server, a server array or server farm, a web server, a network server, an Internet server, a work station, a mini-computer, a main frame computer, a supercomputer, a network appliance, a web appliance, a distributed computing system, multiprocessor systems, processor-based systems, a laptop computer, a tablet computer, a smartphone, or a combination thereof. In one example, computing platform 101 is a disaggregated server. A disaggregated server is a server that breaks up components and resources into subsystems. Disaggregated servers can be adapted to changing storage or compute loads as needed without replacing or disrupting an entire server for an extended period of time. A server could, for example, be broken into modular compute, I/O, power and storage modules that can be shared among other nearby servers.

Circuitry 120 having processing cores 122-1 to 122-m may include various commercially available processors, including without limitation Intel® Atom®, Celeron®, Core (2) Duo®, Core i3, Core i5, Core i7, Itanium®, Pentium®, Xeon® or Xeon Phi® processors, ARM processors, and similar processors. Circuitry 120 may include at least one cache 135 to store data.

Uncore 182 describe functions of a processor that are not in processing cores 122-1, 122-2, . . . 122-m, but which are closely connected to the cores to achieve high performance. Cores contain components of the processor involved in executing instructions, including the arithmetic logic unit (ALU), the floating-point unit (FPU) and level one and level two caches. In contrast, in various embodiments, uncore 182 functions include interconnect controllers, a level three cache, a snoop agent pipeline, an on-die memory controller, and one or more I/O controllers. In an embodiment, uncore 182 is resident in circuitry 120. In an embodiment, uncore 182 includes last level cache 135.

According to some examples, primary memory 130 may be composed of one or more memory devices or dies which may include various types of volatile and/or non-volatile memory. Volatile types of memory may include, but are not limited to, dynamic random-access memory (DRAM), static random-access memory (SRAM), thyristor RAM (TRAM) or zero-capacitor RAM (ZRAM). Non-volatile types of memory may include byte or block addressable types of non-volatile memory having a 3-dimensional (3-D) cross-point memory structure that includes chalcogenide phase change material (e.g., chalcogenide glass) hereinafter referred to as “3-D cross-point memory”. Non-volatile types of memory may also include other types of byte or block addressable non-volatile memory such as, but not limited to, multi-threshold level NAND flash memory, NOR flash memory, single or multi-level phase change memory (PCM), resistive memory, nanowire memory, ferroelectric transistor random access memory (FeTRAM), magneto-resistive random-access memory (MRAM) that incorporates memristor technology, spin transfer torque MRAM (STT-MRAM), or a combination of any of the above. In another embodiment, primary memory 130 may include one or more hard disk drives within and/or accessible by computing platform 101.

Computing platform 101 includes hardware queue manager (HQM) 180 to assist in managing queues of data units. In an embodiment, the data units are packets transmitted to and/or received from network I/O device 110, and packets transferred between cores. In another embodiment, the data units include timer events. In an embodiment, HQM 180 is part of circuitry 120. In another embodiment, HQM 180 is part of uncore 182.

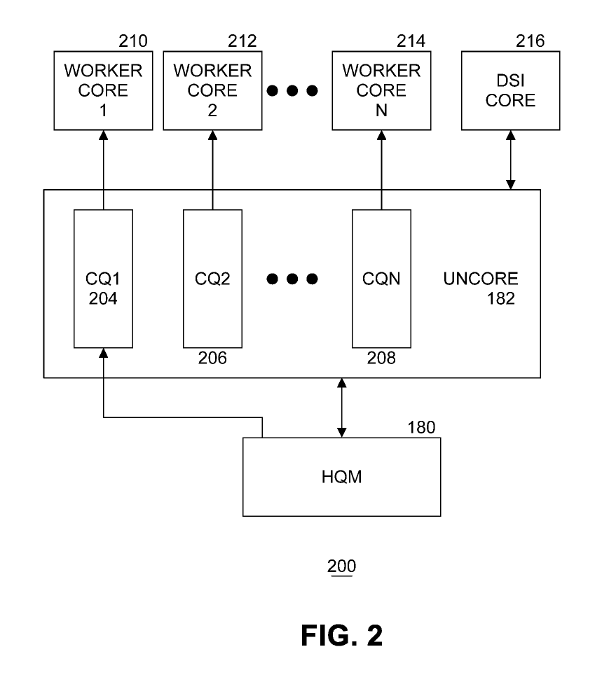

FIG. 2 illustrates an example arrangement of processing cores. Embodiments of the present invention use a loop running on a receive (Rx) device specific interface (DSI) core 216 to control power aware load balancing processing of received packets. DSI core 216 may also be known as a load balancing core. A process executing on DSI core 216 monitors the traffic load incoming from network I/O device 110 to transparently and dynamically enable and disable a plurality of worker cores 1 210, 2 212, . . . N 214, where N is a natural number. In an embodiment, DSI core 216 transparently and dynamically enables and disables threads on worker cores. In an embodiment, DSI core 216 makes network I/O device 110 look like a software agent to HQM 180. DSI core 216 accepts descriptors (e.g., metadata) for incoming packets and enqueues the packet descriptors in queues in HQM 180 for load balancing. DSI core 216 varies the number of worker cores 210, 212, . . . 214 by enabling or disabling the association of worker cores from HQM 180. In embodiments of the present invention, DSI core 216 and worker cores 210, 212, . . . 214 are processing cores 122-1, 122-2, . . . 122-m as described FIG. 1. In one embodiment, worker cores go into and out of sleep state using a MWAIT instruction (for computing platforms having an Intel Architecture instruction set architecture (ISA)) when no work is available.

In an embodiment, uncore 182 includes a plurality of consumer queues CQ 1 204, CQ 2 206, . . . CQ N 208, where N is a natural number, stored in cache 135. Each consumer queue stores zero or more blocks of metadatas. In an embodiment, a block of metadata is a packet descriptor including information describing a packet. In one embodiment, there is a one to one correspondence between each worker core and a consumer queue. For example, worker core 1 210 is associated with CQ 1 204, worker core 2 212 is associated with CQ 2 206, and so on until worker core N 214 is associated with CQ N 208. However, in other embodiments there may be a plurality of consumer queues per worker core. In yet another embodiment, at least one of the worker cores is not associated with a consumer queue. The sizes of the consumer queues may all be the same or may be different in various embodiments. The sizes of the consumer queues are implementation dependent. In at least one embodiment, the consumer queues store metadata describing packets, but not the packets themselves (since the packets are stored in one or more of primary memory 130, cache 135, and storage devices 165 while being processed after receipt from network I/O device 110).

HQM 180 distributes packet processing tasks to enabled worker cores 210, 212, . . . 214 by adding packet descriptors to consumer queues CQ 1 204, CQ 2 206, . . . CQ N 208 in uncore 182. HQM 180 acts as a traffic buffer smoothing out spikes in traffic flow. HQM 180 performs load balancing while considering flow affinity. Disabled worker cores are not allocated any traffic when disabled and can enter low power states semi-statically, or be switched to other duties.

In an embodiment, processing proceeds as follows. DSI core 216 enqueues packet descriptors to HQM 180 via uncore 182. HQM 180 distributes (i.e., load balances) packet descriptors to active consumer queues CQ1 204, CQ 2 206, . . . CQ N 208 in uncore 182. Worker cores 210, 211, . . . 214 get packet descriptors from corresponding consumer queues for packet processing. Worker cores with nothing to do (i.e., there are no packet descriptors in their consumer queues to be processed), go to sleep.

In an embodiment, a control flow proceeds as follows. Within a predetermined interval DSI core 216 counts a number of received packets injected into computing platform 101. In an embodiment, a system of credit is used manage load balancing. Worker cores return credits back to DSI core 216 periodically so DSI core 216 knows both a packet injection rate and a packet consumption rate of the system. A process executing in DSI core 216 computes a required number of enabled worker cores needed to balance power savings and system performance. DSI core 216 sends updated worker core status information to HQM 180. To stop using a worker core, HQM 180 stops inserting packet descriptors into the worker core's consumer queue. To start using a worker core, HQM 180 starts inserting packet descriptors into the worker core's consumer queue. In the context switch case, HQM 180 delivers an interrupt to bring the worker core back to work.

The power aware load balancing approach of embodiments of the present invention rely on a capability of HQM 180 to allow the number of worker cores to be modified transparently to application 160. This capability can be applied at a physical core level such that sibling threads on any given worker core are likely to have a high correlation of sleep state residency.

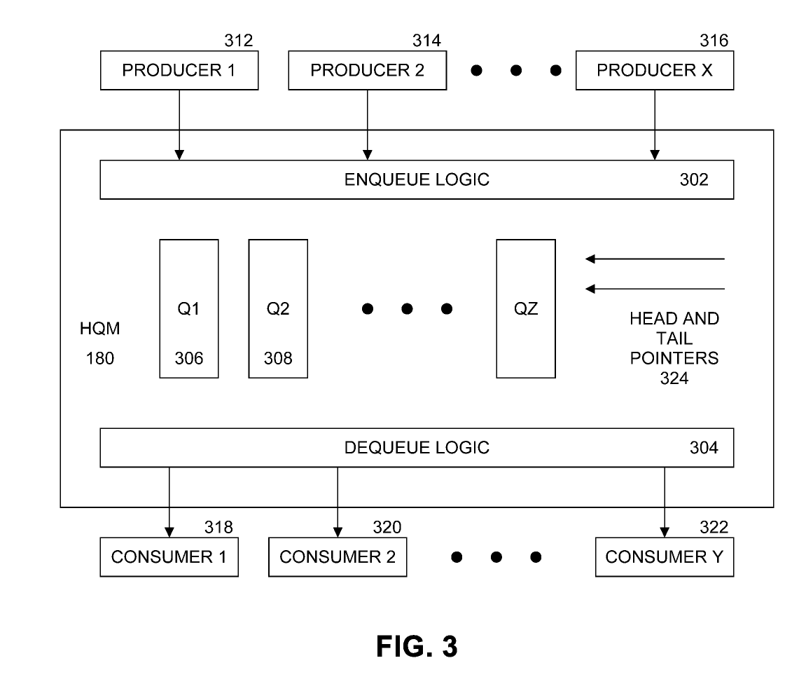

FIG. 3 illustrates an example hardware queue manager (HQM) 180. HQM provides queue management offload functions and load balancing services. HQM 180 provides a hardware managed system of queues and arbiters connecting producers and consumers. HQM 180 includes enqueue logic circuitry 302 to receive data (such packet descriptors for example) from a plurality of producers, such as producer 1 312, producer 2 314, . . . producer X 316, where X is a natural number. Enqueue logic circuitry 302 inserts the data into one of the queues internal to HQM called Q1 306, Q2 308, . . . QZ 310, where Z is a natural number, for temporary storage during load balancing operations. HQM 180 uses a plurality of head and tail pointers 324 to control enqueuing and dequeuing of data in queues Q1 306, Q2 308, . . . QZ 310. HQM 180 includes dequeue logic circuitry 304 to remove the data from a queue and transfer the data to a selected one of consumer 1 318, consumer 2 320, . . . consumer Y, where Y is a natural number. In an embodiment, the values for X, Y, and Z are different, any one or more producers write to more than one queue, any one or more consumers read from more than one queue, and the number of queues is implementation dependent. Further details on the operation of HQM 180 are described in the commonly assigned patent application entitled “Multi-Core Communication Acceleration Using Hardware Queue Device” filed Jan. 4, 2016, published Jul. 6, 2017 as US 2017/0192921 A1, incorporated herein by reference.

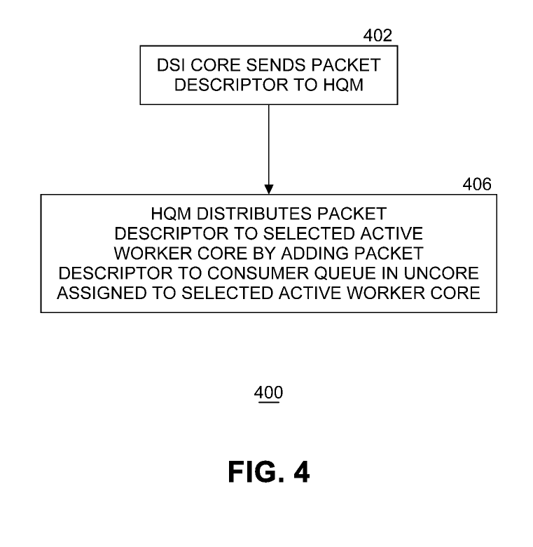

FIG. 4 illustrates an example flow diagram of a process 400 to enqueue and dequeue packet descriptors. At block 402, DSI core 216 sends a packet descriptor (representing a received packet) to HQM 180. At block 406, HQM distributes the packet descriptor to a selected enabled worker core by adding the packet descriptor to the consumer queue in uncore 182 assigned to the selected enabled worker core. HQM 180 dequeues the packet descriptor by removing the packet descriptor from the consumer queue after the worker core processes the packet descriptor, and returns a status back to DSI core 216 via uncore 182.

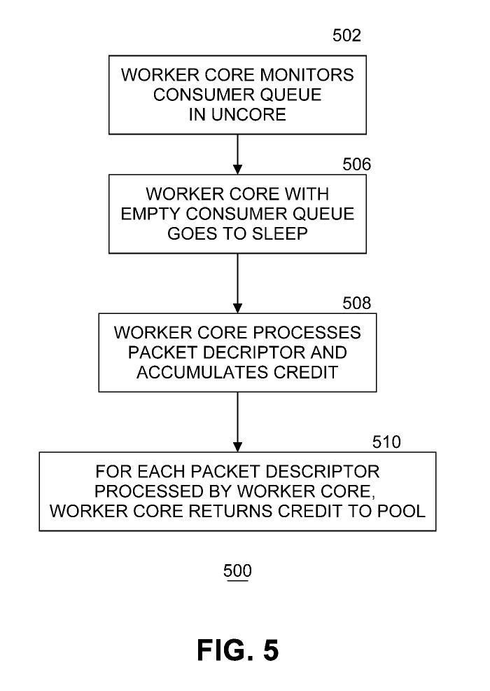

FIG. 5 illustrates an example flow diagram of a process 500 to access packet descriptors by a worker core. At block 502, a worker core (such as one of worker core 1 210, worker core 2 212, . . . worker core N 214) requests a packet descriptor from the consumer queue associated with the worker core in uncore 182 (i.e., one of CQ 1 204, CQ 2 206, . . . CQ N 208). In an embodiment, if a worker core is associated with more than one consumer queue, the worker core identifies a selected consumer queue in the request. If the consumer queue for the worker core is empty, then the worker core performs other tasks or goes to sleep at block 506. In an embodiment, if an invalid packet descriptor is read then it may be assumed the consumer queue is empty. Otherwise the worker core processes the packet descriptor and accumulates a credit at block 508. How the worker core processes the packet descriptor and related packet is implementation dependent. For each packet descriptor processed by the worker core, the worker core returns a credit to the credit pool. In an embodiment, a credit is accumulated by the worker core for each packet descriptor processed.

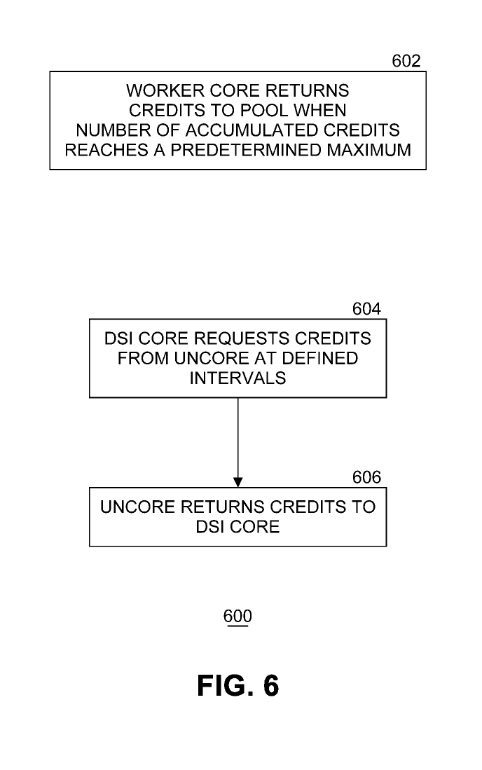

FIG. 6 illustrates an example flow diagram of a process 600 to handle credits. Each worker core returns accumulated credits to the credit pool when the number of accumulated credits reaches a predetermined maximum number for that worker core at block 602. In an embodiment, each worker core has the same maximum number of credits. In another embodiment, worker cores have different maximum numbers of credit limits. The number of credits indicates the number of packet descriptors processed by the worker core. At block 604, at defined intervals DSI core 216 requests the credits from uncore 182. Uncore 182 returns the credits to DSI core 216 at block 606. The number of credits returned indicates the rate of consumption of packet descriptors by the worker cores in the system.

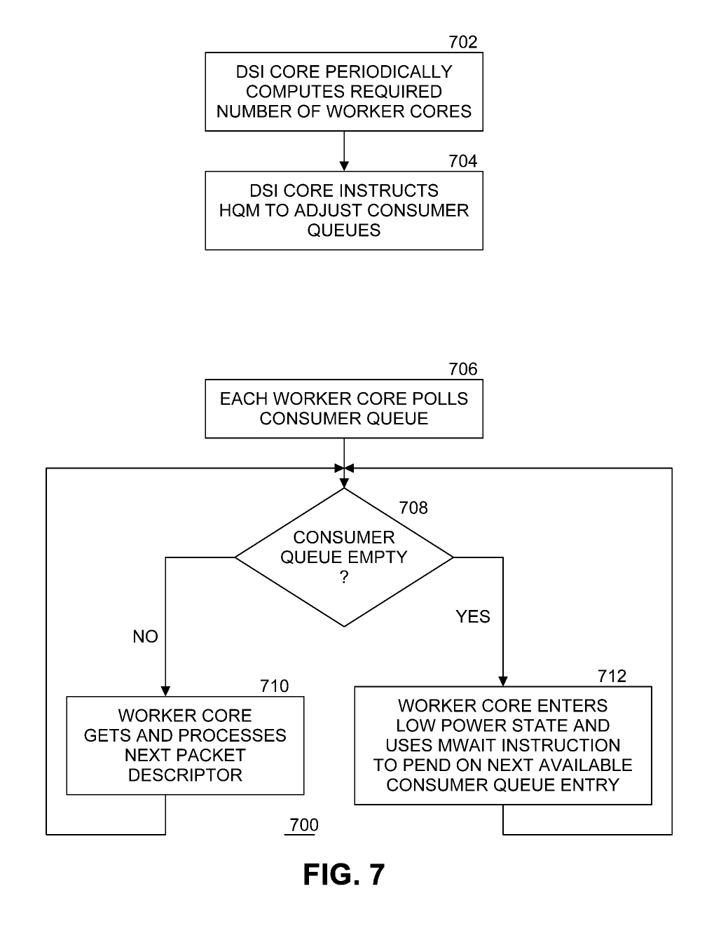

FIG. 7 illustrates an example flow diagram of a first process to control load balancing. At block 702, DSI core 216 periodically computes the number of worker cores required to be enabled to handle the expected traffic. One function of power aware load balancing of cores in computing platform 101 is to dynamically adjust the required number of enabled worker cores so that only the minimum number of worker cores that are needed to handle the expected traffic are enabled. Computing the number of worker cores required to be enabled can be done in several ways. In one embodiment, DSI core 216 counts the number of packet descriptors queued in HQM 180 in a predetermined preceding time window and correlates the number to a target latency value to determine a number of required enabled worker cores. For example, if 100 packet descriptors have been queued and each packet descriptor takes 1 microsecond to process by a worker core, 10 enabled worker cores are needed to achieve a latency target of 10 microseconds. In another embodiment, DSI core 216 determines if more or less packet descriptors have entered HQM 180 than have exited during a preceding predetermined time window. If packet descriptors are entering HQM 180 at a higher rate than packet descriptors are being processed (and exiting), then more worker cores are needed (and vice versa). The number of worker cores to be enabled or disabled is dependent on the rate. In an embodiment, computation of the required number of enabled worker cores is performed in HQM 180 hardware instead of by a process executing on DSI core 216.

At block 704, DSI core 216 instructs HQM 180 to adjust the number of active consumer queues in response to the newly computed number of required enabled worker cores. In an embodiment, HQM 180 adjusts the set of active consumer queues by feeding or starving consumer queues in sufficient number to match the newly computed number of required enabled worker cores. Thus, if the number of required enabled worker cores has gone down from the previous computation by a number of cores (for example, there were ten enabled worker cores, but now only eight enabled worker cores are needed), HQM 180 stops adding packet descriptors to consumer queues 204, 206, . . . 208 for the same number of cores (for example, two consumer queues are no longer being fed). If the number of required enabled worker cores has gone up from the previous computation by a number of cores (for example, there were eight enabled worker cores, but now ten enabled worker cores are needed), HQM 180 starts adding packet descriptors to consumer queues 204, 206, . . . 208 for the same number of cores (for example, two additional consumer queues are no longer being starved and instead are now being fed).

At block 706, each worker queue independently polls the worker core's associated consumer queue (or consumer queues, if a worker core is associated with multiple consumer queues). If the consumer queue is not empty at block 708, the worker core gets and processes the next packet descriptor (i.e., a new packet descriptor) in the consumer queue. Processing loops back to block 708. If the consumer queue is empty at block 708, the worker core enters a low power state at block 712 to pend on a next available (e.g., new) consumer queue entry. That is, the worker core will not process any more packet descriptors until a next available packet descriptor is added to the worker core's consumer queue by HQM 180. In an embodiment, the worker core enters a low power state by executing a MWAIT instruction. In an embodiment, instead of entering a low power state, the worker core is switched to tasks other than processing packet descriptors from the worker core's consumer queue, and sets up an interrupt to trigger on an addition of a new packet descriptor to the worker core's consumer queue. Note that consumer queues can be empty even when they are activated, so in these embodiments the worker core can sleep (or switch) even when enabled. Regardless, the next write to the worker core's consumer queue brings the worker core back to the task of processing packet descriptors. When the worker core is in a low power state, computing platform 101 uses less power. Processing loops back to block 708.

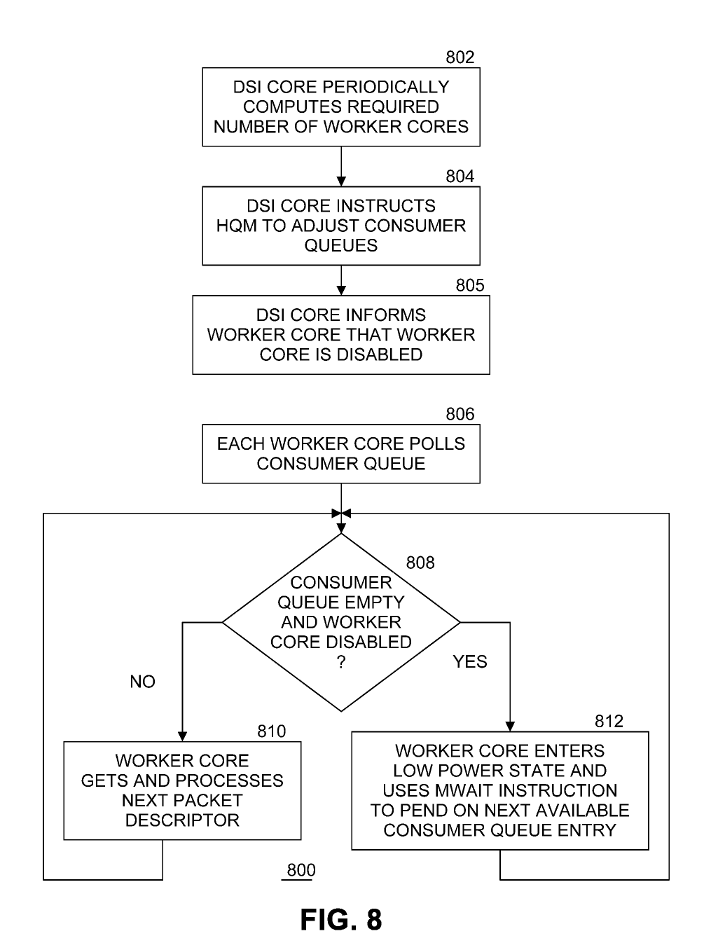

FIG. 8 illustrates an example flow diagram of a second process to control load balancing. At block 802, DSI core 216 periodically computes the number of worker cores required to be enabled to handle current traffic as in FIG. 7. At block 804, DSI core 216 instructs HQM 180 to adjust the number of consumer queues in response to the newly computed number of required enabled worker cores as in FIG. 7. At block 805, DSI core 216 informs each worker core that is no longer needed that the worker core is disabled. In an embodiment, this may be accomplished by using a shared memory “disable” flag for each worker core. When the disable flag is set, the worker core is disabled. When the disable flag is not set, the worker core is enabled.

At block 806, each worker queue independently polls the worker core's associated consumer queue (or consumer queues, if a worker core is associated with multiple consumer queues), regardless of enable/disable status. If at block 808 the consumer queue is empty and the worker core's disable flag is set, the worker core enters a low power state at block 812 to pend on a next available (i.e. new packet descriptor) consumer queue entry. That is, the worker core will not process any more packet descriptors until a next available packet descriptor is added to the worker core's consumer queue by HQM 180. In an embodiment, the worker core enters a low power state by executing a MWAIT instruction. In an embodiment, instead of entering a low power state, the worker core is switched to tasks other than processing packet descriptors from the worker core's consumer queue, and sets up an interrupt to trigger on an addition of a new packet descriptor to the worker core's consumer queue. When the worker core is in a low power state, computing platform 101 uses less power. Processing loops back to block 808. If at block 808 the consumer queue is not empty or the consumer queue is empty but the worker core's disable flag is not set (i.e., the worker core is still enabled), then the worker core gets and processes the next packet descriptor (if there is one) in the consumer queue at block 810. Processing loops back to block 708. In this embodiment, implementation of the disable flag for each worker core results in worker cores polling so long as they (and their associated consumer queues) are enabled, regardless of whether the worker core's consumer queue is empty. This prevents worker cores from bouncing in and out of low power states due to temporary empty consumer queues.

In an embodiment, the process for adjusting the number of enabled worker cores is dynamic and transparent to application 160. The process compares the injected packet rate with the packet consumption rate. If the system processes packets at a slower rate than the packet inject rate, additional worker cores are enabled to boost the packet consumption rate and vice versa.

An example of pseudo code of a process for adjusting the number of active worker cores is shown below. Other implementations within the scope of embodiments of the present invention can be designed.

Copyright 2018 Intel Corporation
Initialize number of worker cores to N (e.g., 12)
Initialize DSI core credits ‘C’ to some maximum ‘T’
Initialize core increase/decrease step S = 1 (use 2/4 if HT enabled)
Parameters:

| | |
|---|---|
| Panic - panic level per core | ; Used to add workers if excessive traffic builds up in HQM |

Pkts - Packets issued per core; Determines how frequently the process runs

| | |
|---|---|
| LWM - 5%; | ; Trigger for deciding there are too many workers enabled |
| HWM - 20%; | ; Trigger for deciding there are too few workers enabled |

```
Repeat
      DSI core sends (Pkts * N) packets: C = C − Pkts*N; Spend this many credits
          between each run
      Fetch returned credits from uncore R: C = C + R; Credits returned by consumers
      Calculate/update number of worker cores (N):
            IF (C < T − Panic * N): N = N + S; Credit fell below panic level
            ELSE IF (Pkts * N − R > Pkts * HWM * N): N = N + S; Packets arrived >
              packets processed
            ELSE IF (R − Pkts * N > Pkts * LWM * N): N = N − S; Packets processed
              > packets arrived
      ELSE: N = N
```

The parameters can be adjusted to trade off latency for power efficiency according to system requirements. In the example pseudo code, the variable “pkts” determines the frequency of adjusting the number of enabled worker cores, balancing response time (maximum latency) and efficiency. In an embodiment, latency is defined as the time from when a packet enters the system until the packet is finished processing by a worker core. Maximum, average, and minimum latencies can be determined. [o066] For applications with varying traffic loads, embodiments of the present invention provide better power savings (e.g., a higher percentage of worker cores in a lower power state) than a static distribution approach.

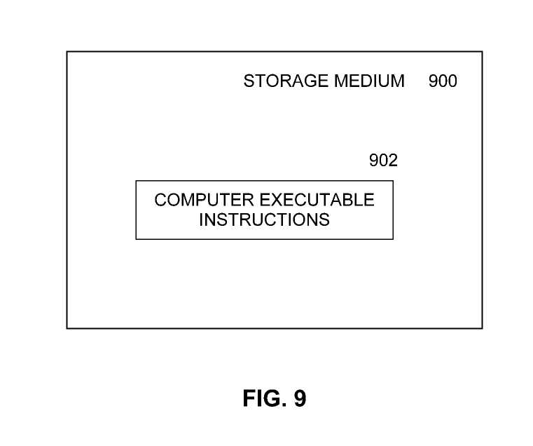

Variations to the power aware load balancing approach of embodiments of the present invention may be used. In one embodiment, a time of day (TOD) process could be applied, whereby the maximum number of enabled worker cores is adjusted every hour (for example) based on expected traffic and some of the worker cores are transitioned in and out of deep sleep states (or to other activities). Worker cores excluded by the TOD process would not be available for the dynamic process described above (outside of exception paths). [o068] FIG. 9 illustrates an example of a storage medium 900. Storage medium 900 may comprise an article of manufacture. In some examples, storage medium 900 may include any non-transitory computer readable medium or machine readable medium, such as an optical, magnetic or semiconductor storage. Storage medium 900 may store various types of computer executable instructions, such as instructions 902 to implement logic flows 400, 500, 600, 700, and 800 of FIG. 4 through FIG. 8, respectively. Examples of a computer readable or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

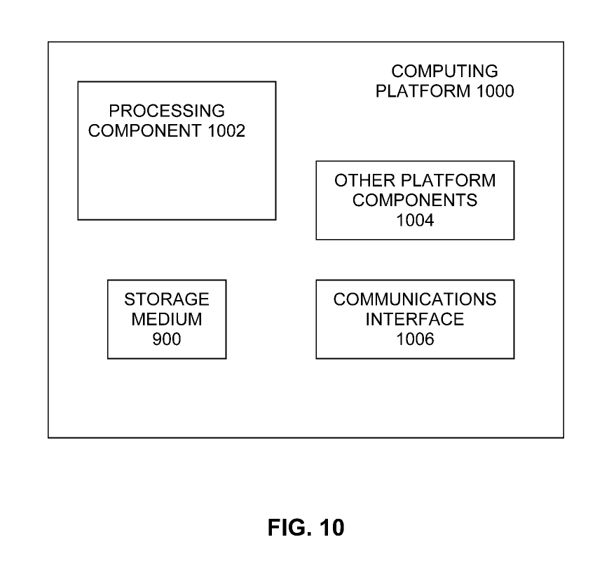

FIG. 10 illustrates an example computing platform 1000. In some examples, as shown in FIG. 10, computing platform 1000 may include a processing component 1002, other platform components 1004 and/or a communications interface 1006.

According to some examples, processing component 1002 may execute processing operations or logic for instructions stored on storage medium 900. Processing component 1002 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, device drivers, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

In some examples, other platform components 1004 may include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), types of non-volatile memory such as 3-D cross-point memory that may be byte or block addressable. Non-volatile types of memory may also include other types of byte or block addressable non-volatile memory such as, but not limited to, multi-threshold level NAND flash memory, NOR flash memory, single or multi-level PCM, resistive memory, nanowire memory, FeTRAM, MRAM that incorporates memristor technology, STT-MRAM, or a combination of any of the above. Other types of computer readable and machine-readable storage media may also include magnetic or optical cards, an array of devices such as Redundant Array of Independent Disks (RAID) drives, solid state memory devices (e.g., USB memory), solid state drives (SSD) and any other type of storage media suitable for storing information.

In some examples, communications interface 1006 may include logic and/or features to support a communication interface. For these examples, communications interface 1006 may include one or more communication interfaces that operate according to various communication protocols or standards to communicate over direct or network communication links or channels. Direct communications may occur via use of communication protocols or standards described in one or more industry standards (including progenies and variants) such as those associated with the PCIe specification. Network communications may occur via use of communication protocols or standards such those described in one or more Ethernet standards promulgated by IEEE. For example, one such Ethernet standard may include IEEE 802.3. Network communication may also occur according to one or more OpenFlow specifications such as the OpenFlow Switch Specification.

The components and features of computing platform 1000, including logic represented by the instructions stored on storage medium 900 may be implemented using any combination of discrete circuitry, ASICs, logic gates and/or single chip architectures. Further, the features of computing platform 1000 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary computing platform 1000 shown in the block diagram of FIG. 10 may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASIC, programmable logic devices (PLD), digital signal processors (DSP), FPGA, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Included herein are logic flows or schemes representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow or scheme may be implemented in software, firmware, and/or hardware. In software and firmware embodiments, a logic flow or scheme may be implemented by computer executable instructions stored on at least one non-transitory computer readable medium or machine readable medium, such as an optical, magnetic or semiconductor storage. The embodiments are not limited in this context.

Some examples are described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
computing a number of enabled worker cores to process received packets;
adjusting a number of active consumer queues based at least in part on the number of enabled worker cores, consumer queues being associated with worker cores;
monitoring, by at least one worker core, the consumer queue associated with the at least one worker core;
getting and processing a packet descriptor describing a received packet from the consumer queue by the at least one worker core when the consumer queue is not empty; and
entering a low power state by the at least one worker core based on the consumer queue being empty and pending on a new packet descriptor being entered into the consumer queue.

2. The method of claim 1, comprising leaving the low power state by the at least one worker core when the new packet descriptor is entered into the consumer queue.

3. The method of claim 1, comprising the at least one worker core entering the low power state by executing a wait instruction.

4. The method of claim 1, comprising the at least one worker core switching to a task other than packet descriptor processing and setting up an interrupt to trigger on an addition of a new packet descriptor to the at least one worker core's consumer queue, instead of entering the low power state.

5. The method of claim 1, comprising setting a disabled flag for the at least one worker core when the at least one worker core is not needed to process the received packets.

6. The method of claim 5, comprising entering a low power state by the at least one worker core when the consumer queue is empty and the at least one worker core's disabled flag is set, and pending on the new packet descriptor being entered into the consumer queue.

7. The method of claim 1, wherein computing the number of enabled worker cores to process the received packets comprises counting a number of packet descriptors enqueued in consumer queues in a preceding predetermined time window and correlating the number of enqueued packet descriptors to a target latency value to determine the number of enabled worker cores.

8. The method of claim 1, wherein computing the number of enabled worker cores to process the received packets comprises determining if more packet descriptors have been enqueued into consumer queues than have been dequeued from consumer queues during a preceding predetermined time window and if so, enabling one or more worker cores.

9. The method of claim 1, comprising adding the new packet descriptor to the consumer queue in response to receiving a packet.

10. At least one tangible machine-readable medium comprising a plurality of instructions that in response to being executed by a processor having a plurality of worker cores cause the processor to:
compute a number of enabled worker cores to process received packets;
adjust a number of active consumer queues based at least in part on the number of enabled worker cores, consumer queues being associated with worker cores;
monitor, by at least one worker core, the consumer queue associated with the at least one worker core;
get and process a packet descriptor describing a received packet from the consumer queue by the at least one worker core when the consumer queue is not empty; and
enter a low power state by the at least one worker core based on the consumer queue being empty and pending on a new packet descriptor being entered into the consumer queue.

11. The at least one tangible machine-readable medium of claim 10, comprising instructions to leave the low power state by the at least one worker core when the new packet descriptor is entered into the consumer queue.

12. The at least one tangible machine-readable medium of claim 10, comprising instructions to the at least one worker core to switch to a task other than packet descriptor processing and set up an interrupt to trigger on an addition of a new packet descriptor to the at least one worker core's consumer queue, instead of entering the low power state.

13. The at least one tangible machine-readable medium of claim 10, comprising instructions to set a disabled flag for the at least one worker core when the at least one worker core is not needed to process the received packets.

14. The at least one tangible machine-readable medium of claim 13, further comprising instructions to enter a low power state by the at least one worker core based on the consumer queue being empty and the at least one worker core's disabled flag being set, and pend on the new packet descriptor being entered into the consumer queue.

15. The at least one tangible machine-readable medium of claim 10, wherein instructions to compute the number of enabled worker cores to process the received packets comprise instructions to count a number of packet descriptors enqueued in consumer queues in a preceding predetermined time window and correlate the number of enqueued packet descriptors to a target latency value to determine the required number of enabled worker cores.

16. The at least one tangible machine-readable medium of claim 10, wherein instructions to compute the number of enabled worker cores to process the received packets comprise instructions to determine if more packet descriptors have been enqueued into consumer queues than have been dequeued from consumer queues during a preceding predetermined time window and if so, enabling one or more worker cores.

17. A processor comprising:
a plurality of worker cores;
a load balancing core to compute a number of enabled worker cores to process received packets; and
a hardware queue manager to adjust a number of active consumer queues based at least in part on the number of enabled worker cores, each consumer queue being associated with a worker core;
wherein each worker core to monitor the consumer queue associated with the worker core, to get and process a packet descriptor describing a received packet from the consumer queue when the consumer queue is not empty; and to enter a low power state based on the consumer queue being empty and pend on a new packet descriptor being entered into the consumer queue.

18. The processor of claim 17, comprising the worker core to leave the low power state when the new packet descriptor is entered into the consumer queue.

19. The processor of claim 17, comprising the worker core to enter the low power state by executing a wait instruction.

20. The processor of claim 17, comprising the worker core to switch to a task other than packet descriptor processing and set up an interrupt to trigger on an addition of a new packet descriptor to the worker core's consumer queue, instead of entering the low power state.

21. The processor of claim 17, comprising the load balancing core to set a disabled flag for the worker core when the worker core is not needed to process the received packets.

22. The processor of claim 21, comprising the worker core to enter a low power state when the consumer queue is empty and the worker core's disabled flag is set, and pend on the new packet descriptor being entered into the consumer queue.

23. The processor of claim 7, comprising the hardware queue manager to add the new packet descriptor to the consumer queue in response to receiving a packet.
